(19) United States
(12) Patent Application Publication
(10) Pub. No.: US 2022/0262355 A1
(43) Pub. Date: Aug. 18, 2022

(54) SYSTEM AND METHOD FOR IMPROVING SPEECH CONVERSION EFFICIENCY OF ARTICULATORY DISORDER

(71) Applicants: National Yang Ming Chiao Tung University, Taipei (TW); MacKay Medical College, New Taipei City (TW)

(72) Inventors: Ying-Hui LAI, Taipei City (TW); Pei-Chun LI, New Taipei City (TW); Chen-Kai LEE, Taipei City (TW)

(21) Appl. No.: 17/497,545

(22) Filed: Oct. 8, 2021

(30) Foreign Application Priority Data
Feb. 5, 2021 (TW) 110104509

(51) Int. Cl. G10L 15/197; G10L 15/06; G10L 15/30; G10L 15/22

(52) U.S. Cl. CPC G10L 15/197; G10L 15/22; G10L 15/30; G10L 15/063

(57) ABSTRACT

A system and method for improving speech conversion efficiency of Articulatory disorder, The method comprises the following steps: First generate a set of text to be recording (not considered in user difference and model difference). It will cover specific phonemes of language and tone distribution relationship. Then the user can train the voice conversion model (or other voice processing model) based on the voice recorded by the user. At the same time, the generated text will also be changed by the characteristics of the currently adopted model (For example: by changing the time-frequency resolution relationship of sentences in the text). Then generate more representative texts so that users can read more helpful training corpus to improve the processing efficiency of the system.

### FIELD OF THE INVENTION

The present invention relates generally to a system and method for increasing the dysarthria patients' speech conversion efficiency, and more particularly to a method which automatically generates personalized corpus text considering personalized language features.

### BACKGROUND OF INVENTION

At present, the performance of speech conversion systems is usually evaluated in the level of speech recognition using subjectivity lexicon recognition test. In order to verify the efficiency of the present speech conversion model, the subject needs to take a series of pronunciation tests in selecting-fitting process(may take several weeks), and currently there is no customized test based on the characteristics of the subject's speech sound, disease process, etc., for improving the test process. For example, the subject may record the pronunciations for thousands of words (or sentences) aimlessly in the test process, and then the conversion results of the present speech conversion model are applied to evaluate whether the subject needs to record more. In this situation, the subject easily to get annoyed by the long recording time and the unstable results. Furthermore, the test result would be with high uncertainty and errors because it affected by the subjective responses of the subject, such as stamina, emotion, age, linguistic competence and expressiveness, it is not satisfactory.

At present, there is no automatic generation method for common corpus texts considering personalized language features. In addition, there is no technology for real-time core corpus generation according to the phonetic feature processed by speech conversion system. Many popular speech signal processing systems (e.g. speech conversion) are designed based on deep learning architecture. However, for this type of signal processing architecture, representative training corpus is very important. The present methods mainly use mass speech data to try to attain the representative target, but the collection of mass speech data sometimes causes inconvenience to the users, as well as to the dysarthria patients. Therefore, for the users difficult to record much speech (e.g. dysarthria patients), it is very difficult for the patients to complete corpus recording. To solve the above problem, the present invention designs a real-time customized corpus text generation system in the concept of optimization theory (e.g. genetic algorithm), and proposes a system-user interactive mode to increase the training corpus recording efficiency. The invention reduces the corpus recording efficiency of users when using speech conversion system, so as to reduce the patients' difficulty in recording a lot of corpora when using the speech conversion (or other speech processing) system. In addition, the present invention generates new texts according to the deficiencies in current speech conversion system (e.g. poorly converted phonemes and tones, sentence time variation, etc.). These new texts enable the users to record correct training speech, so as to reduce the patients' recording load efficiently.

### SUMMARY OF THE INVENTION

In view of this, the patent can convert unsound parts (e.g. phonemes, tone, etc.) based on speech conversion system, giving the users a direction of corpus recording, so that the efficiency of speech conversion system can be increased while the difficulty in phonetic transcription is reduced for users. This practice can enhance the usability and difficulty of the proposed system, so as to enhance the chance of success in the speech signal processing products based on deep learning.

The present invention relates to a system and method for increasing the dysarthria patients' speech conversion efficiency, including a text database module, including a corpus text database, storing a plurality of corpus candidate word lists; a model database module, including a tone model database which stores the tone models; an analysis model database which stores the analysis models; a model parameter database, storing a plurality of model parameters; a corpus generation module, connected to the text database module and the model database module, including a first corpus generation unit, generating an initial word list from the text database module; a second corpus generation unit, generating a kernel word list according to the text database module; a speech capture module, the speech of a normal articulator is recorded into a training corpus according to the initial word list or the kernel word list; the speech of an abnormal articulator is recorded into a sample corpus; a speech conversion module, connected to the speech capture module, including a matching unit, matching the training corpus and the sample corpus, marking an abnormally articulated and a correctly articulated sentence of the sample corpus; an analytic unit, the abnormal articulation is analyzed by a plurality of tone models and a plurality of analysis models to obtain an enhanced tone parameter, a model characteristic parameter is derived from the differences among the analysis models; an output module, connected to the speech conversion module, calculating a speech recognition accuracy and connected to an output equipment.

The present invention relates to a system and method for enhancing the dysarthria patients' speech conversion efficiency. The steps of the method are described below. S1. a corpus generation module extracts a plurality of corpus candidate word lists from a corpus text database of a text database module, a first corpus generation unit of the corpus generation module generates an initial word list according to the corpus candidate word lists; S2. a normal articulator records a training corpus through a speech capture module according to the initial word list, an abnormal articulator records an nth sample corpus through the speech capture module according to the initial word list, and the training corpus and the nth sample corpus are transmitted to a speech conversion module; S3. a matching unit of the speech conversion module matches the training corpus and the nth sample corpus, marking an abnormally articulated and a correctly articulated sentence of the nth sample corpus; an analytic unit, after the correct articulation and the unsoundly processed abnormal articulation are analyzed by a plurality of tone models and a plurality of analysis models, an nth enhanced tone parameter is obtained, and an nth model characteristic parameter is obtained according to the differences among the analysis models, and transmitted to the corpus generation module; S4. a second corpus generation unit of the corpus generation module generates an nth kernel word list according to the nth enhanced tone parameter and the nth model characteristic parameter, the abnormal articulator records a No. n+1 sample corpus according to the nth kernel word list, and the No. n+1 sample corpus is transmitted to the speech conversion module; S5. a matching unit of the speech conversion module matches the training corpus and the No. n+1 sample corpus, marking an abnormally articulated and a correctly articulated sentence of the No. n+1 sample corpus; an analytic unit analyzes the correct articulation and the unsoundly processed abnormal articulation through a plurality of tone models and a plurality of analysis models to obtain the No. n+1 enhanced tone parameter, the No. n+1 model characteristic parameter and the No. n+1 speech recognition accuracy.

Preferably, the corpus generation module can set up the articulation disorder type of the abnormal articulator; the enhanced tone parameter and the model characteristic parameter store the model parameters according to the articulation disorder type.

Preferably, the speech conversion module includes a natural language processing unit, performing sentence segmentation or word segmentation for the training corpus or the sample corpus according to the initial word list or the kernel word list of the corpus generation module 30.

Preferably, different texts can be the material of candidate word lists and sentences of this system.

Preferably, the speech recorded by this system is the algorithm development material of speech conversion systems (or hearing aids, artificial electronic ears, speech recognizers, etc.).

Preferably, this system converts unsound phonemes and tones and sentence time variation characteristic to generate new texts.

Preferably, through objective guide, the speech conversion system used in this system can be but not limited to speech recognizer, acoustoelectric characteristic analysis, phoneme and tone characteristics, STOI, PESQ, MCD, phoneme distribution relationship and so on. After evaluation, the processed unsound speech is quantized to the objective function of this system.

Preferably, the speech processing system of this system can improve the deficiencies (e.g. phonemes, tones, sound articulation, etc.) in the unsound abnormal articulation processed by the analytic unit.

Preferably, this system can execute core text generation according to the characteristics of the model (e.g. considering anterior and posterior phonetic features, with memory effectiveness).

Preferably, this system designs a real-time customized corpus text generation system in the concept of optimization theory (e.g. genetic algorithm), and proposes a system-user interactive mode to enhance the training corpus recording efficiency.

Preferably, this system generates the core text according to the model characteristics used by current converting system (e.g. considering time sequence, spectral space relation and attention model), so as to enhance the user's recording efficiency.

### BRIEF DESCRIPTION OF THE DRAWINGS

FIG. 1 shows a schematic diagram of system for enhancing the dysarthria patients' speech conversion efficiency.

FIG. 2 shows a flow diagram of method for enhancing the dysarthria patients' speech conversion efficiency.

FIG. 3 shows a schematic diagram 1 of corpus generation module.

FIG. 4 shows a schematic diagram 2 of corpus generation module.

FIG. 5 shows an embodiment of enhancing dysarthria patients' speech conversion efficiency.

### DETAILED DESCRIPTION OF THE INVENTION

### Embodiment 1

### System for Improving Speech Conversion Efficiency of Articulatory Disorder

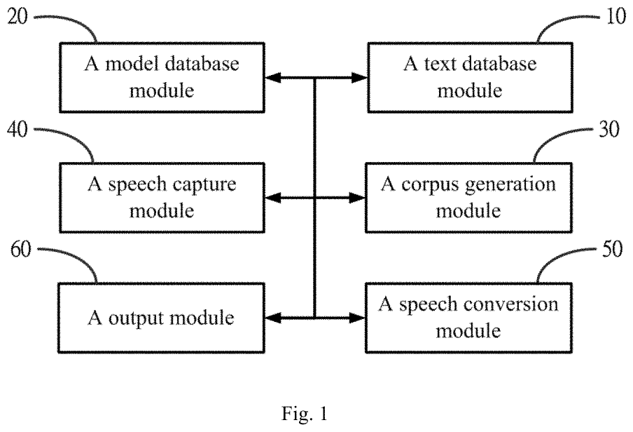

The present invention relates to a system and method for enhancing the dysarthria patients' speech conversion efficiency, wherein the system is shown in FIG. 1, including a text database module 10, including a corpus text database, which stores a plurality of corpus candidate word lists; a model database module 20, including a tone model database for storing the tone models; an analysis model database for storing the analysis models; a model parameter database for storing a plurality of model parameters; a corpus generation module 30, connected to the text database module 10 and the model database module 20, including a first corpus generation unit, generating an initial word list from the text database module 10; a second corpus generation unit, generating a kernel word list according to the text database module 10; a speech capture module 40, the speech of a normal articulator is recorded into a training corpus according to the initial word list or the kernel word list; the speech of an abnormal articulator is recorded into a sample corpus; a speech conversion module 50, connected to the speech capture module 40, including a matching unit, matching the training corpus and the sample corpus, marking an abnormally articulated and a correctly articulated sentence of the sample corpus; an analytic unit, the processed unsound abnormal articulation is analyzed by a plurality of tone models and a plurality of analysis models to obtain an enhanced tone parameter, a model characteristic parameter is obtained according to the differences among the analysis models; an output module 60, connected to the speech conversion module 5, calculating a speech recognition accuracy, connected to an output equipment.

In the aforesaid embodiment, the analytic unit considers time sequence, spectral space relation, inflection characteristic and uses conversion model characteristic.

In the aforesaid embodiment, the enhanced tone parameter and the model characteristic parameter optimize the model parameters of the model parameter database, the optimized cost function includes the minimum mean square error and speech understanding oriented functions (STOI, SII, NCM, HASPI, ASR scores, etc.), speech quality oriented functions (PESQ, HASQI, SDR, etc.), and the model parameters in the model parameter database are updated after optimization.

A preferred embodiment of the present invention, a system and method for enhancing the dysarthria patients' speech conversion efficiency, the tone models include using speech recognizer, acoustoelectric characteristic analysis, phoneme and tone characteristics, STOI, PESQ, MCD, phoneme distribution relation and so on.

A preferred embodiment of the present invention, a system and method for enhancing the dysarthria patients' speech conversion efficiency, the analysis models include attention model, model with treatment of time, end to end learning model, natural language processing system and so on.

A preferred embodiment of the present invention, a system and method for enhancing the dysarthria patients' speech conversion efficiency, the text database module 10 includes an articulation disorder text database, storing a plurality of articulation disorder candidate word lists.

An embodiment of the present invention, a system and method for enhancing the dysarthria patients' speech conversion efficiency, wherein the corpus generation module 30 includes an articulation disorder type input setting of the abnormal articulator; the enhanced tone parameter and the model characteristic parameter store the model parameters according to the articulation disorder type.

A preferred embodiment of the present invention, a system and method for enhancing the dysarthria patients' speech conversion efficiency, the speech conversion module 50 includes a natural language processing unit, executing sentence segmentation or word segmentation for the training corpus or the sample corpus according to the initial word list or the kernel word list of the corpus generation module 30.

An embodiment of the present invention, a system and method for enhancing the dysarthria patients' speech conversion efficiency, wherein the corpus text database includes an expansion unit for increasing the content of the corpus text database, e.g. Academia Sinica colloquialism corpus, Academia Sinica Chinese corpus, NCCU spoken Chinese corpus, elementary school frequent words, Hanlin text dictionary and so on.

An embodiment of the present invention, a system and method for enhancing the dysarthria patients' speech conversion efficiency, wherein the output equipment can be, but not limited to tabulating machine, display screen, speech, etc.

### Embodiment 2

### Method for Improving Speech Conversion Efficiency of Articulatory Disorder

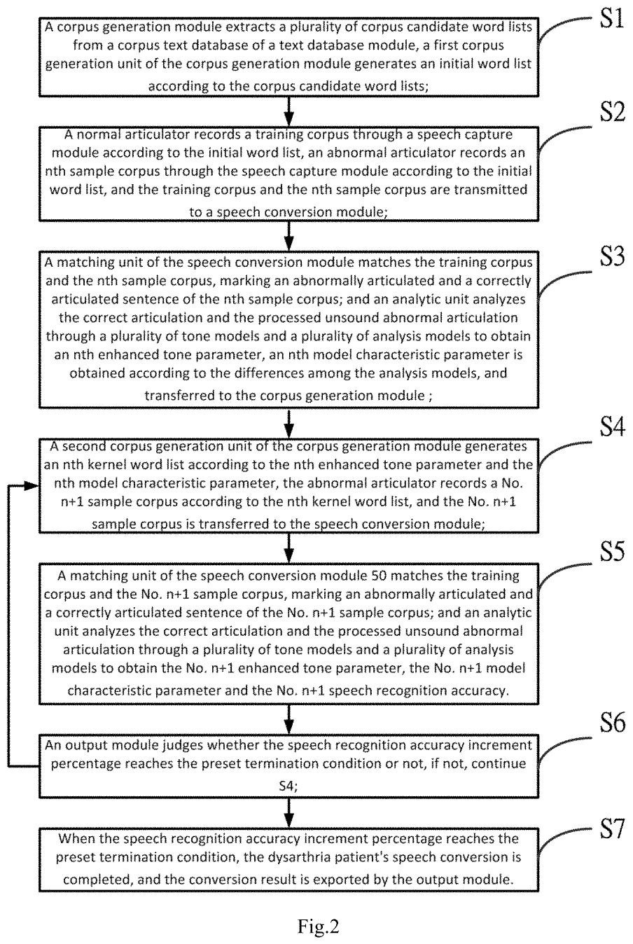

The present invention relates to a system and method for enhancing the dysarthria patients' speech conversion efficiency, as shown in FIG. 2, wherein the method has the following steps.

S1. A corpus generation module 30 extracts a plurality of corpus candidate word lists from a corpus text database of a text database module 10, a first corpus generation unit of the corpus generation module generates an initial word list according to the corpus candidate word lists;
S2. A normal articulator records a training corpus through a speech capture module 40 according to the initial word list, an abnormal articulator records an nth sample corpus through the speech capture module 40 according to the initial word list, and the training corpus and the nth sample corpus are transmitted to a speech conversion module 50;
S3. A matching unit of the speech conversion module 50 matches the training corpus and the nth sample corpus, marking an abnormally articulated and a correctly articulated sentence of the nth sample corpus; and an analytic unit analyzes the correct articulation and the processed unsound abnormal articulation through a plurality of tone models and a plurality of analysis models to obtain an nth enhanced tone parameter, an nth model characteristic parameter is obtained according to the differences among the analysis models, and transferred to the corpus generation module 30;
S4. A second corpus generation unit of the corpus generation module 30 generates an nth kernel word list according to the nth enhanced tone parameter and the nth model characteristic parameter, the abnormal articulator records a No. n+1 sample corpus according to the nth kernel word list, and the No. n+1 sample corpus is transferred to the speech conversion module 50;
S5. A matching unit of the speech conversion module 50 matches the training corpus and the No. n+1 sample corpus, marking an abnormally articulated and a correctly articulated sentence of the No. n+1 sample corpus; and an analytic unit analyzes the correct articulation and the processed unsound abnormal articulation through a plurality of tone models and a plurality of analysis models to obtain the No. n+1 enhanced tone parameter, the No. n+1 model characteristic parameter and the No. n+1 speech recognition accuracy.

Preferably, in the aforesaid embodiment, a termination condition for a speech recognition accuracy increment percentage can be preset in an input unit of the corpus generation module 30 before the process, when the speech recognition accuracy increment percentage reaches the termination condition, the speech conversion stops, the steps are described below.

S6. An output module judges whether the speech recognition accuracy increment percentage reaches the preset termination condition or not, if not, continue S4;
S7. When the speech recognition accuracy increment percentage reaches the preset termination condition, the dysarthria patient's speech conversion is completed, and the conversion result is exported by the output module.

A preferred embodiment of the present invention, the speech recognition accuracy computing equation is expressed as follows, represented by Word error rate (WER) and Character Error Rate (CER):

$$WER = \frac{{S}_{w} + {D}_{w} + {I}_{w}}{{N}_{w}} \qquad ( 1 )$$

S_{w} is the number of words substituted, D_{w} is the number of words deleted, I_{w} is the number of words inserted, N_{w}=S_{w}+D_{w}+C_{w}.
(Note: C_{w}=number of correct words and number of correct tones.)

$$CER = \frac{{S}_{C} + {D}_{C} + {I}_{C}}{{N}_{C}} \qquad ( 2 )$$

S_{C} is the number of characters substituted, D_{C} is the number of characters deleted, I_{C} is the number of characters inserted, N_{C}=S_{C}+D_{C}+C_{C}.
(Note: C_{C}=number of correct characters and number of correct tones.)

A preferred embodiment of the present invention, the termination condition computing equation is expressed as follows, when the WAcc and CAcc are larger than X %, or the number of iterations exceeds N and the accuracy is not increased anymore, the system is stopped. (Note: variables X and N can be determined by the user, X is assumed to be 90% and N is 10 in current embodiment.)

WA_{CC}(%)=(1−WER)*100 (3)

CA_{CC}(%)=(1−CER)*100 (4)

A preferred embodiment of the present invention, a system and method for enhancing the dysarthria patients' speech conversion efficiency, a user inputs an articulation disorder region of the abnormal articulator in the input unit, the corpus generation module 30 extracts a plurality of articulation disorder candidate word lists corresponding to the articulation disorder region from an articulation disorder text database of the text database module 10 according to the articulation disorder region. The corpus generation module 30 generates the initial word list and the kernel word list according to the articulation disorder candidate word lists.

A preferred embodiment of the present invention, after evaluation, the processed unsound speech is quantized to an objective function of this system, the objective function of this system is the relation expressed as the minimization equation (5).

$$D = {\sum }_{n = 0}^{N} ( {w}_{1} {\sum }_{i = 1}^{22} {( {Initial}_{i} - {initial}_{i} )}^{2} + {w}_{2} {\sum }_{j = 1}^{39} {( {Final}_{i} - {final}_{i} )}^{2} + {w}_{3} {\sum }_{k = 1}^{K} {( {T}_{k} - {t}_{k} )}^{2} ) \qquad ( 5 )$$

(Note: w₁, w₂ and w₃ are the attention weights for adjusting initial, final and tone pattern (T). The Initial and initial are the target and estimated frequency of each initial respectively. The Final and final are the estimated frequency of each final. The T and t are the target and estimated frequency of each tone pattern respectively. The variable N is the estimated total number assessed, K is the number of tone patterns.)

An Chinese embodiment of the present invention, a system and method for enhancing the dysarthria patients' speech conversion efficiency, wherein the forms of corpus delivered from the corpus generation unit include individual plurality of single word combinations (Table 1. The monosyllabic Mandarin word represented by traditional Chinese character and its Hanyu Pinyin.), a plurality of double word combinations (Table 2. The disyllabic Mandarin word represented by traditional Chinese characters and its Hanyu Pinyin.) and a plurality of phrase combinations (Table 3), or the mixture of the single word combinations, the double word combinations and the phrase combinations.

| List A1 | | List A2 | | List A3 | | List B1 | | List B2 | | List B3 | |
|---|---|---|---|---|---|---|---|---|---|---|---|
| Item | Word | Item | Word | Item | Word | Item | Word | Item | Word | Item | Word |
| zhi1 | [symbol] | di4 | [symbol] | zhi1 | [symbol] | jing1 | [symbol] | shi4 | [symbol] | yi3 | [symbol] |
| shang4 | [symbol] | yu2 | [symbol] | he2 | [symbol] | yuan2 | [symbol] | cheng2 | [symbol] | cheng2 | [symbol] |
| hou4 | [symbol] | jian4 | [symbol] | yu2 | [symbol] | yu3 | [symbol] | ji4 | [symbol] | ru2 | [symbol] [symbol] |
| heng2 | [symbol] | zi4 | [symbol] | ji3 | [symbol] | qi2 | [symbol] | yu3 | [symbol] | si4 | [symbol] |
| jin4 | [symbol] | shuo1 | [symbol] | ying4 | [symbol] | xia4 | [symbol] | bian4 | [symbol] | du4 | [symbol] |
| qu4 | [symbol] | xiao3 | [symbol] | wu2 | [symbol] | jiang4 | [symbol] | du4 | [symbol] | cong2 | [symbol] |
| mu4 | [symbol] | kan4 | [symbol] | jie2 | [symbol] | bian4 | [symbol] | fei1 | [symbol] | ling4 | [symbol] |
| xian1 | [symbol] | mu4 | [symbol] | ban4 | [symbol] | si4 | [symbol] | ying3 | [symbol] | lo4 | [symbol] |
| jie3 | [symbol] | iou2 | [symbol] | chu4 | [symbol] | fei1 | [symbol] | xi2 | [symbol] | jian3 | [symbol] |
| dian4 | [symbol] | jie3 | [symbol] | zhan3 | [symbol] | kao3 | [symbol] | ru4 | [symbol] | gei3 | [symbol] |
| ying2 | [symbol] | feng1 | [symbol] | qi1 | [symbol] | guang1 | [symbol] | jiao1 | [symbol] | jun1 | [symbol] |
| chu2 | [symbol] | zhan3 | [symbol] | diao4 | [symbol] | liao4 | [symbol] | qiang2 | [symbol] | zhuan1 | [symbol] |
| ll2 | [symbol] | gai1 | [symbol] | xin4 | [symbol] | tan2 | [symbol] | liu4 | [symbol] | yang2 | [symbol] |
| wei3 | [symbol] | chu2 | [symbol] | pian4 | [symbol] | huan1 | [symbol] | kuang4 | [symbol] | tui1 | [symbol] [symbol] |
| ge1 | [symbol] | a1 | [symbol] | zeng1 | [symbol] | yon1 | [symbol] | mian3 | [symbol] | xi3 | [symbol] |
| ban3 | [symbol] | yin3 | [symbol] | tuo1 | [symbol] | cu4 | [symbol] | wu1 | [symbol] | kuang4 | [symbol] |
| fan2 | [symbol] | zhen4 | [symbol] | long2 | [symbol] | se4 | [symbol] | zhoi1 | [symbol] | mao4 | [symbol] |
| pi2 | [symbol] | sui2 | [symbol] | gang3 | [symbol] | xian2 | [symbol] | guan4 | [symbol] | bang4 | [symbol] |
| ao4 | [symbol] | ni2 | [symbol] | wei1 | [symbol] | chu3 | [symbol] | lun2 | [symbol] | pian1 | [symbol] |
| kong3 | [symbol] | bang1 | [symbol] | fa2 | [symbol] | zhui1 | [symbol] | pao3 | [symbol] | shun4 | [symbol] |
| za2 | [symbol] | pi2 | [symbol] | kao4 | [symbol] | shun4 | [symbol] | song1 | [symbol] | fan1 | [symbol] |
| zhuo1 | [symbol] | long2 | [symbol] | shon2 | [symbol] | dong3 | [symbol] | cang2 | [symbol] | yao2 | [symbol] |
| oil | [symbol] | ao4 | [symbol] | nai4 | [symbol] | meng2 | [symbol] | xuan2 | [symbol] | qiu1 | [symbol] |
| ti4 | [symbol] | ho1 | [symbol] | mi3 | [symbol] | lang2 | [symbol] | o1 | [symbol] | xuan2 | [symbol] |
| sen1 | [symbol] | qing4 | [symbol] | sen1 | [symbol] | pi4 | [symbol] | he4 | [symbol] | he4 | [symbol] |

TABLE 2

| | | |
|---|---|---|
| Item 1: | [symbol] | jin4 bu4 |
| Item 2: | [symbol] | zhang1 lang2 |
| Item 3: | [symbol] | yong3 gan3 |
| Item 4: | [symbol] | tou2 fa3 |
| Item 5: | [symbol] | lai2 lin2 |
| Item 6: | [symbol] | ju3 xing2 |
| Item 7: | [symbol] | hou4 hul3 |
| Item 8: | [symbol] | gong1 da3 |
| Item 9: | [symbol] | lou2 ti1 |
| Item 10: | [symbol] | yan3 jiang3 |
| Item 11: | [symbol] | biao3 xian4 |
| Item 12: | [symbol] | shan1 ding3 |
| Item 13: | [symbol] | ka3 pian4 |
| Item 14: | [symbol] | xing2 ren2 |
| Item 15: | [symbol] | kong1 fu1 |
| Item 16: | [symbol] | zhu4 yuan4l |
| Item 17: | [symbol] | qiao1 men2 |
| Item 18: | [symbol] | da3 zhan4 |
| Item 19: | [symbol] | fan4 we [symbol] 2 |
| Item 20: | [symbol] | ji4 hua4 |
| Item 21: | [symbol] | sao4 ba3 |
| Item 22: | [symbol] | xia4 ji4 |
| Item 23: | [symbol] | wan2 zheng3 |
| Item 24: | [symbol] | jiao4 che1 |
| Item 25: | [symbol] | cao1 xin1 |
| Item 26: | [symbol] | yu2 lei4 |
| Item 27: | [symbol] | jian4 zhu2 |
| Item 28: | [symbol] | zi1 shi4 |
| Item 29: | [symbol] | cun2 zai4 |
| Item 30: | [symbol] | wu3 xiou1 |
| Item 31: | [symbol] | zhi2 ye4 |
| Item 32: | [symbol] | he2 neng2 |
| Item 33: | [symbol] | jun1 shi1 |
| Item 34: | [symbol] | xie2 e4 |
| Item 35: | [symbol] | shen2 shi4 |
| Item 36: | [symbol] | hei1 bao4 |
| Item 37: | [symbol] | nan2 ti2 |
| Item 38: | [symbol] | sha1 yu2 |
| Item 39: | [symbol] | mo4 qi4 |
| Item 40: | [symbol] | dao3 you2 |
| Item 41: | [symbol] | du4 guo4 |
| Item 42: | [symbol] | yue4 pu3 |
| Item 43: | [symbol] | suan1 tong4 |
| Item 44: | [symbol] | kai2 chuang4 |
| Item 45: | [symbol] | ti2 sheng1 |
| Item 46: | [symbol] | chang2 mian4 |
| Item 47: | [symbol] | chu2 ta3 |
| Item 48: | [symbol] | ru4 mi2 |
| Item 49: | [symbol] | ling3 dui4 |
| Item 50: | [symbol] | guo4 qi2 |

[symbol]

indicates data missing or illegible when filed

TABLE 3

| | |
|---|---|
| [symbol] | [symbol] |
| I failed to attend the | Most northerners love |
| reception yesteray | to cook dumplings |
| [symbol] | [symbol] |
| My aunt will bring | The letterbox before Christmas |
| you rederence books | is full of greeting cards |
| [symbol] | [symbol] |
| Or let's meet at another | The wines of this company are |
| time | very expensive |
| [symbol] | [symbol] |
| I want to apply for that | The temperature at the door is |
| kind of water gun with you | seven degrees below zero |
| [symbol] | [symbol] |
| I only talk to your | She lost a gray plaid |
| manager | top |
| [symbol] | [symbol] |
| I can take the fligh this | It took him an hour to repair |
| Friday | the butons |
| [symbol] | [symbol] |
| I'll reserve the chairman's | Musicians nee some |
| seat | talent |
| [symbol] | [symbol] |
| Organize this drinking | Grandpa always like to |
| glass and give it to me | discuss with him |
| [symbol] | [symbol] |
| Everyone needs to pay ten | Early in the morning, the birds |
| Taiwan dollars | were playing outside |
| [symbol] | [symbol] |
| I am worried about my | Dont' forget to bring volleyball |
| sont's test scores | when you go out |

An embodiment of the present invention, a system and method for enhancing the dysarthria patients' speech conversion efficiency, wherein the quantity of corpora of the training corpus can set multiple word combinations or sentence combinations as one training unit.

An embodiment of the present invention, a system and method for enhancing the dysarthria patients' speech conversion efficiency, wherein the model parameters include the proportion or number of specific consonants, the proportion or number of specific vowels, the proportion or number of specific consonant-vowel combinations, and the proportion or number of specific ultrasonic band features.

An embodiment of the present invention, a system and method for enhancing the dysarthria patients' speech conversion efficiency, wherein the initial word list covers all the vowels and consonants of language (e.g. if there are tones, those which are likely to be confused can be selected), covers the known tones which are likely to be confused in the language (e.g. similar manners and positions of articulation), and generates comparable materials. Shorter unit of organization of material is the priority (e.g. single word priority).

An Chinese embodiment of the present invention, a system and method for enhancing the dysarthria patients' speech conversion efficiency, wherein the matching unit compares the phoneme recognitions before and after conversion, as shown in Table 4. (The matching unit is used to compare the phoneme recognition before and after conversion. Note that the “?” in the table represents the result of whether the speech recognizer recognizes the speech which was processed by the conversion system correctly or not.)

TABLE 4

| | Feature conversion | Voice recognition |
|---|---|---|
| Before conversion | result before | result after |
| (target word) | conversion | conversion |
| [symbol] -“zhi1” | [symbol] -“zhi1” | [symbol] -“zhi1” |
| [symbol] -“chi1” | [symbol] -“zhi1” | [symbol] -“chi1 |
| [symbol] -“shi1” | [symbol] -“zhi1” | [symbol] -“shi1” |
| [symbol] -“zhi1” | [symbol] -“zhi1” | [symbol] -“zhi1” |
| [symbol] -“chi1 | [symbol] -“zhi1” | [symbol] -“zhi1” |
| [symbol] -“shi1” | [symbol] -“zhi1” | [symbol] -“zhi1” |

An Chinese embodiment of the present invention, a system and method for enhancing the dysarthria patients' speech conversion efficiency, wherein the analytic unit expands the single word combination, double word combination and phrase combination sampling of examples in the same length for single word combination of unstable articulation, as shown in Table 5.

TABLE 5

| | | | |
|---|---|---|---|
| [symbol] => | [symbol] => | | |
| “zhi1” | “zhi1 chi2” | | |
| [symbol] => | [symbol] => | Recognition result | => Will it still be “ [symbol] ”? |
| “chi1” | “chi1 fai4” | after conversion | “zhi1 fai4” |
| [symbol] => | [symbol] => | | => Will it still be “ [symbol] ”? |
| “shi1” | “chi1 zuo4” | | “zhi1 zuo4” |
| [symbol] => | [symbol] => | | |
| “zhi1” | “tou4 zhi1” | | |
| [symbol] => | => | | |
| “chi1” | “hao3 chi1” | | |
| [symbol] => | [symbol] => | | |
| “shi1” | “bu4 chi1” | | |

In the aforesaid embodiment, if a speech recognition accuracy increment percentage is not reached after the single word combination of unstable articulation expands examples in the same length, the material unit with the error unit is expanded continuously, till the recognition result before conversion reaches or exceeds the speech recognition accuracy increment percentage.

An embodiment of the present invention, a system and method for enhancing the dysarthria patients' speech conversion efficiency, wherein the speech conversion module 50 uses the Principle of Least Effort, for the articulation units which can be smoothly converted by the analytic unit, the speech samples of expansion training are generated automatically by the user's voice. For the articulation units which cannot be converted smoothly, new training materials are generated according to the aforesaid expansion length concept.

### Embodiment 3

### The Corpus Generation Module

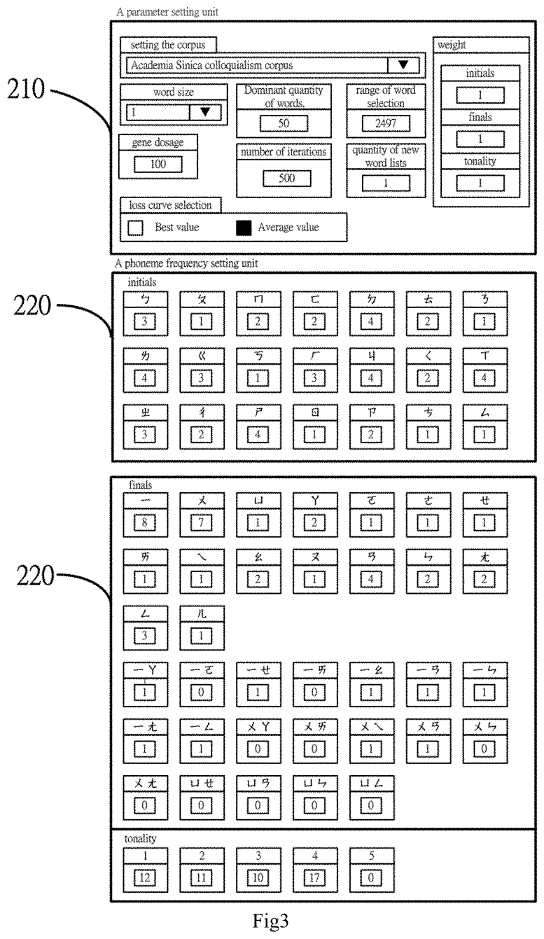

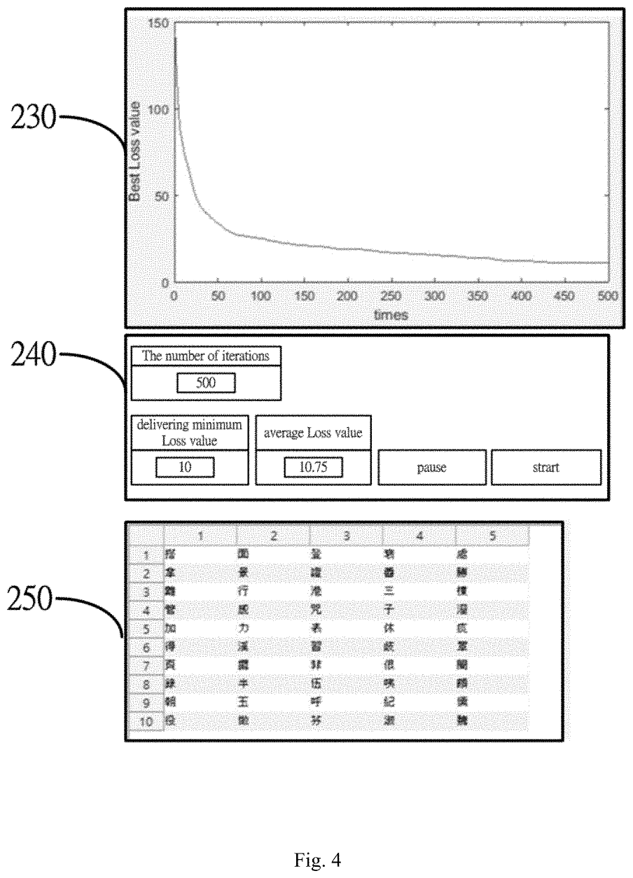

An Chinese embodiment of the present invention, a system and method for enhancing the dysarthria patients' speech conversion efficiency, as shown in FIG. 3 and FIG. 4, wherein the corpus generation module 30 includes ; a parameter setting unit 210 for setting the corpus, word size, dominant quantity of words, range of word selection, gene dosage, number of iterations, quantity of new word lists, weight and loss curve selection; a phoneme frequency setting unit 220, the initials, finals and tonality are set according to different languages; an input unit, inputting the corpus of the speech capture module a speech analysis calculating unit, obtaining the speech of the input unit to work out a loss curve according to the setting conditions of parameter setting unit and the phoneme frequency setting unit; a LOSS curve display unit 230, displaying the loss curve and presenting a Best Loss Value curve with time in real time mode, the Best Loss Value curve converges till the termination condition is reached a LOSS value output unit 240, delivering minimum Loss value, average Loss value and the number of iterations a new word list generation unit 250, using genetic algorithm to generate a new word list (also known as text) when the termination condition (number of iterations) is tenable.

An embodiment of the present invention, a system and method for enhancing the dysarthria patients' speech conversion efficiency, wherein the enhanced tone parameter and the model characteristic parameter obtained by the analytic unit are stored in the model parameter database, they can be optimized with the existing model parameters. The optimized cost function includes minimum mean square error and speech understanding oriented functions (STOI, SII, NCM, HASPI, ASR scores, etc.), and speech quality oriented functions (PESQ, HASQI, SDR, etc.).

An embodiment of the present invention, a system and method for enhancing the dysarthria patients' speech conversion efficiency, wherein after the model parameters are optimized, the articulation disorder sentences of the articulation disorder candidate word lists of the articulation disorder text database corresponding to the articulation disorder type are adjusted.

An embodiment of the present invention, a system and method for enhancing the dysarthria patients' speech conversion efficiency, wherein the corpus generation module 30 is shown in FIG. 4, the Loss curve displayed by the LOSS curve display unit 230 is presented in real time mode, it converges till the termination condition is reached. The LOSS value output unit 240 displays minimum Loss value, average Loss value and the number of iterations. When the termination condition (number of iterations) of the new word list generation unit 250 is tenable, the new word list (also known as text) is generated.

### Embodiment 4

### Method for Enhancing the Dysarthria Patients' Speech Conversion Efficiency

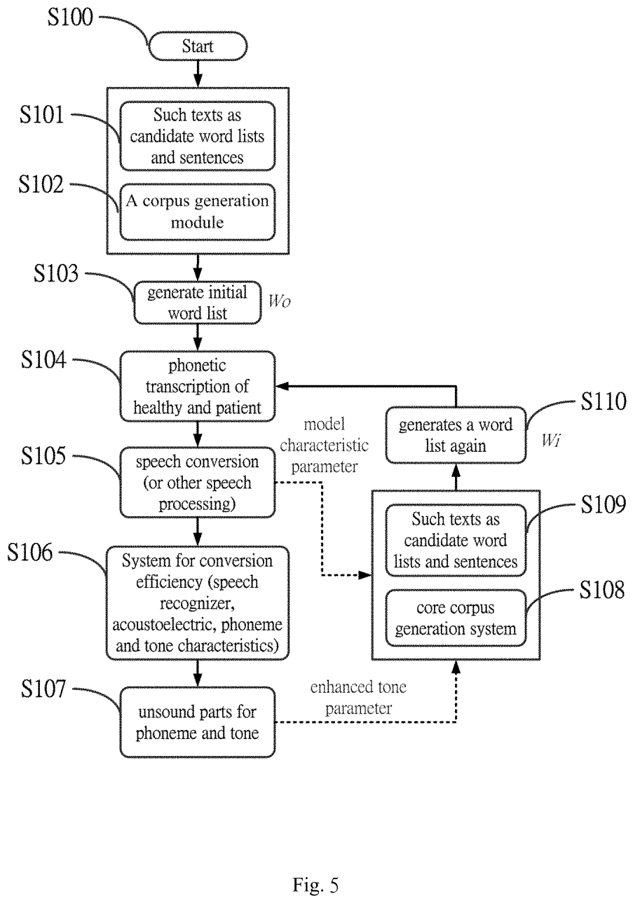

An embodiment of the present invention, a system and method for enhancing the dysarthria patients' speech conversion efficiency, the process is shown in FIG. 5:

S100˜S102. Such texts as candidate word lists and sentences are prepared for this system to choose, different texts can be used as the material of candidate word lists and sentences of this system.
S103. This system gives distribution objective based on target words to the core corpus text to generate initial word list (Wo).
S104. The user executes phonetic transcription based on initial word list (Wo), so as to obtain training corpus;
S105. The obtained training corpus is used as the training material of speech conversion (or other speech processing) system, so as to complete the model training
S106. The objective indicator includes speech recognizer, acoustoelectric characteristic analysis and phoneme and tone characteristics for evaluation.
S107. The unsound parts processed by current model are counted and converted into “enhanced tone parameter”, meanwhile S105 considers the model characteristic used in current speech conversion system (or other speech processing system), which is converted into “model characteristic parameter”.
S108˜S110. The “core corpus generation system” generates a word list (Wi) again according to the “enhanced tone parameter” and “model characteristic parameter”. In other words, this system can generate word list (Wi) again according to current unsound part processed by speech processing system and considering current model characteristic, and then the word list (Wi) is generated again, and the user reads the new training corpus again.
Repeat S104, the speech conversion (or other speech processing) system executes training again according to new training corpus, so as to enhance the effectiveness of system. The user optimizes the speech conversion system continuously according to S104 to S110, the system processing efficiency is improved continuously by user-system interdependent behavior pattern.

This system can more efficiently guide the patient to read appropriate training statements, the processing efficiency of speech conversion (or other speech processing) system is enhanced by each correct training statement acquisition process of the patient. To be more specific, the method of this patent can be used to generate an appropriate direction of speech acquisition, so as to increase the benefit of training corpus to current model, to reduce the use-cost of speech conversion (or other speech processing) system, and to increase the processing efficiency of outside test statements (unseen statements during training).

Although the present invention has been explained in relation to its preferred embodiment, it is to be understood that many other possible modifications and variations can be made without departing from the spirit and scope of the present invention as hereinafter claimed.

1. A system and method for enhancing the dysarthria patients' speech conversion efficiency, wherein the method has the following steps:
S1. A corpus generation module extracts a plurality of corpus candidate word lists from a corpus text database of a text database module, a first corpus generation unit of the corpus generation module generates an initial word list according to the corpus candidate word lists;
S2. A normal articulator records a training corpus through a speech capture module according to the initial word list, an abnormal articulator records an nth sample corpus through the speech capture module according to the initial word list, and the training corpus and the nth sample corpus are transmitted to a speech conversion module;
S3. A matching unit of the speech conversion module matches the training corpus and the nth sample corpus, marking an abnormally articulated and a correctly articulated sentence of the nth sample corpus; and an analytic unit analyzes the correct articulation and the processed unsound abnormal articulation through a plurality of tone models and a plurality of analysis models to obtain an nth enhanced tone parameter, an nth model characteristic parameter is obtained according to the differences among the analysis models, and transferred to the corpus generation module;
S4. A second corpus generation unit of the corpus generation module generates an nth kernel word list according to the nth enhanced tone parameter and the nth model characteristic parameter, the abnormal articulator records a No. n+1 sample corpus according to the nth kernel word list, and the No. n+1 sample corpus is transferred to the speech conversion module;
S5. A matching unit of the speech conversion module matches the training corpus and the No. n+1 sample corpus, marking an abnormally articulated and a correctly articulated sentence of the No. n+1 sample corpus; and an analytic unit analyzes the correct articulation and the processed unsound abnormal articulation through a plurality of tone models and a plurality of analysis models to obtain the No. n+1 enhanced tone parameter, the No. n+1 model characteristic parameter and the No. n+1 speech recognition accuracy.

2. The System and method for improving speech conversion efficiency of Articulatory disorder of claim 1, wherein a termination condition for a speech recognition accuracy increment percentage can be preset in an input unit of the corpus generation module before the process, when the speech recognition accuracy increment percentage reaches the termination condition, the speech conversion stops, the steps are described below:
S6. An output module judges whether the speech recognition accuracy increment percentage reaches the preset termination condition or not, if not, continue S4;
S7. When the speech recognition accuracy increment percentage reaches the preset termination condition, the dysarthria patient's speech conversion is completed, and the conversion result is exported by the output module.

3. The System and method for improving speech conversion efficiency of Articulatory disorder of claim 2, wherein inputs an articulation disorder region of the abnormal articulator in the input unit, the corpus generation module extracts a plurality of articulation disorder candidate word lists corresponding to the articulation disorder region from an articulation disorder text database of the text database module according to the articulation disorder region, the corpus generation module generates the initial word list and the kernel word list according to the articulation disorder candidate word lists.

4. The System and method for improving speech conversion efficiency of Articulatory disorder of claim 1, wherein the speech recognition accuracy computing equation is expressed as follows, represented by Word error rate (WER) and Character Error Rate (CER):
$$WER = \frac{{S}_{w} + {D}_{w} + {I}_{w}}{{N}_{w}} , CER = \frac{{S}_{C} + {D}_{C} + {I}_{C}}{{N}_{C}} .$$

5. The System and method for improving speech conversion efficiency of Articulatory disorder of claim 1, wherein the termination condition computing equation is expressed as follows, when the WAcc and CAcc are larger than X %, or the number of iterations exceeds N and the accuracy is not increased anymore, the system is stopped:
WA_{CC}(%)=(1−WER)*100, CA_{CC}(%)=(1−CER)*100.

6. The System and method for improving speech conversion efficiency of Articulatory disorder of claim 1, wherein the processed unsound speech is quantized to an objective function of this system, the objective function of this system is the relation expressed as the minimization equation:
$$D = {\sum }_{n = 0}^{N} ( {w}_{1} {\sum }_{i = 1}^{22} {( {Initial}_{i} - {initial}_{i} )}^{2} + {w}_{2} {\sum }_{j = 1}^{39} {( {Final}_{i} - {final}_{i} )}^{2} + {w}_{3} {\sum }_{k = 1}^{K} {( {T}_{k} - {t}_{k} )}^{2} ) .$$

7. The System and method for improving speech conversion efficiency of Articulatory disorder of claim 1, wherein the analytic unit expands the single word combination, double word combination and phrase combination sampling of examples in the same length for single word combination of unstable articulation.

8. The System and method for improving speech conversion efficiency of Articulatory disorder of claim 1, wherein the corpus text database includes an expansion unit for increasing the content of the corpus text database.

9. A system for enhancing the dysarthria patients' speech conversion efficiency, including a text database module, including a corpus text database, which stores a plurality of corpus candidate word lists; a model database module, including a tone model database for storing the tone models; an analysis model database for storing the analysis models; a model parameter database for storing a plurality of model parameters; a corpus generation module, connected to the text database module and the model database module, including a first corpus generation unit, generating an initial word list from the text database module; a second corpus generation unit, generating a kernel word list according to the text database module; a speech capture module, the speech of a normal articulator is recorded into a training corpus according to the initial word list or the kernel word list; the speech of an abnormal articulator is recorded into a sample corpus; a speech conversion module, connected to the speech capture module, including a matching unit, matching the training corpus and the sample corpus, marking an abnormally articulated and a correctly articulated sentence of the sample corpus; an analytic unit, the processed unsound abnormal articulation is analyzed by a plurality of tone models and a plurality of analysis models to obtain an enhanced tone parameter, a model characteristic parameter is obtained according to the differences among the analysis models; an output module, connected to the speech conversion module, calculating a speech recognition accuracy, connected to an output equipment.

10. The System for improving speech conversion efficiency of Articulatory disorder of claim 9, wherein the text database module includes an articulation disorder text database, storing a plurality of articulation disorder candidate word lists.
